(19) United States
(12) Patent Application Publication
(10) Pub. No.: US 2010/0052839 A1
(43) Pub. Date: Mar. 4, 2010

(54) Transformers and Methods of Manufacture Thereof

(76) Inventors: Koen Mertens, Villach (AT); Marc Tiebout, Finkenstein (AT); Konrad Hirsch, Blaustein (DE)

Correspondence Address: SLATER & MATSIL LLP, 17950 PRESTON ROAD, SUITE 1000, DALLAS, TX, 75252, US

(21) Appl. No.: 12/204,081

(22) Filed: Sep. 4, 2008

(51) Int. Cl. H01F 27/28

(52) U.S. Cl. 336/232; 336/105

(57) ABSTRACT

Transformers and methods of manufacture thereof are disclosed. In one embodiment, a transformer includes a semiconductor workpiece and a packaging system disposed over the semiconductor workpiece. The packaging system includes a redistribution layer. At least a portion of at least one winding of the transformer is disposed in the redistribution layer of the packaging system.

### TECHNICAL FIELD

The present invention relates generally to semiconductor devices, and more particularly to transformers.

### BACKGROUND

Semiconductor devices are used in a variety of electronic applications, such as personal computers, cell phones, digital cameras, and other electronic equipment, as examples. Semiconductor devices are typically fabricated by sequentially depositing insulating or dielectric layers, conductive layers, and semiconductive layers of material over a semiconductor substrate, and patterning the various layers using lithography to form circuit components and elements thereon.

A transformer is an electrical device that transfers energy. A transformer has an input side including a primary winding and an output side including a secondary winding. Electrical energy applied to the primary winding is converted to a magnetic field which induces a current in the secondary winding. The current in the secondary winding carries energy to a load connected to the secondary winding. The energy applied to the primary winding is usually in the form of a changing voltage, which creates a constantly changing current in the primary winding, causing a changing magnetic field. The changing magnetic field produces a current in the secondary winding.

Transformers are typically used to convert energy or to isolate an energy source. Transformers can convert energy on the primary winding to a different voltage level on the secondary winding by using different turn counts on the primary and secondary windings. The voltage ratio of the transformer is the same as the turn ratio of the primary and secondary windings. Transformers may be used to isolate the energy source from the destination energy source, for safety reasons or to allow a voltage offset between the source and the load. Furthermore, transformers may also be used to transform impedance.

Transformers are generally divided into two main types: power transformers and signal transformers. Power transformers are used to convert voltages and provide operating power for electrical devices. Signal transformers are used to transfer information from one form or location to another form or location.

In some semiconductor device applications, transformers are required, such as in radio frequency (RF) circuits, analog circuits, power amplifiers, or other types of semiconductor devices. Using external transformers with semiconductor devices can be expensive and can increase the bill-of-materials (BOM) for an application. Furthermore, external transformers are large and require a large amount of space.

Forming transformers in conductive material layers of semiconductor devices results in transformers having a low quality factor (Q). The thin metal layers of semiconductor devices limit the type, size, and operating characteristics of the transformer that can be formed. An attempt to increase the thickness of conductive material layers in order to build an on-chip transformer would result in increased costs for the semiconductor devices.

Thus, what are needed in the art are improved transformer designs for semiconductor device applications.

### SUMMARY OF THE INVENTION

Technical advantages are generally achieved by embodiments of the present invention, which include novel designs for transformers and methods of manufacture thereof.

In accordance with one embodiment, a transformer includes a semiconductor workpiece, and a packaging system disposed over the semiconductor workpiece. The packaging system includes a redistribution layer. At least a portion of at least one winding of the transformer is disposed in the redistribution layer of the packaging system.

The foregoing has outlined rather broadly the features and technical advantages of embodiments of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a cross-sectional view of a packaged semiconductor workpiece in accordance with embodiments of the present invention, wherein at least a portion of a winding of a transformer is disposed in a redistribution layer of a packaging system for the semiconductor workpiece;

FIG. 2 illustrates a top view of a first winding of a transformer disposed in a redistribution layer of a packaging system in accordance with an embodiment;

FIG. 3 shows a top view of a second winding of the transformer disposed in a conductive material layer of a semiconductor workpiece;

FIG. 4 shows a top view of the second winding of FIG. 3 disposed over the first winding of FIG. 2;

FIGS. 5 and 6 show top views of a second winding of a transformer formed in two conductive material layers of a semiconductor workpiece;

FIG. 7 shows a cross-sectional view of the second winding in the two conductive material layers of the semiconductor workpiece shown in FIGS. 5 and 6, with a first winding of a transformer shown in FIG. 2 disposed over the portion of the second winding in the upper conductive material layer;

FIGS. 8 through 10 show top views of windings of a transformer in accordance with another embodiment;

FIG. 11 shows a perspective view of the windings of FIGS. 8 through 10 disposed over one another;

FIG. 12 shows a top view of another embodiment, wherein first and second windings of a transformer are both formed in a redistribution layer of a packaging system; and

FIG. 13 shows a cross-sectional view of the embodiment shown in FIG. 12.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Embodiments of the present invention involve vertically stacking primary and secondary windings of a transformer in a semiconductor workpiece and/or in the packaging layers of the semiconductor workpiece. On-chip metallization layers, e.g., the upper conductive material layers of the semiconductor workpiece, are used to form the secondary windings, and a redistribution layer of a packaging system is used to form the primary windings, in some embodiments. Transformers with windings having one or more turns may be formed, and the on-chip metal levels may be used for the crossings and bridges of the winding formed in the redistribution layer. If a second redistribution layer is available in the packaging system, transformers may furthermore be formed only in the packaging system, without requiring the use of silicon in the semiconductor workpiece below the transformer.

The present invention will be described with respect to preferred embodiments in a specific context, namely implemented in semiconductor device applications that require transformers. The invention may also be applied, however, to other applications where transformers are used.

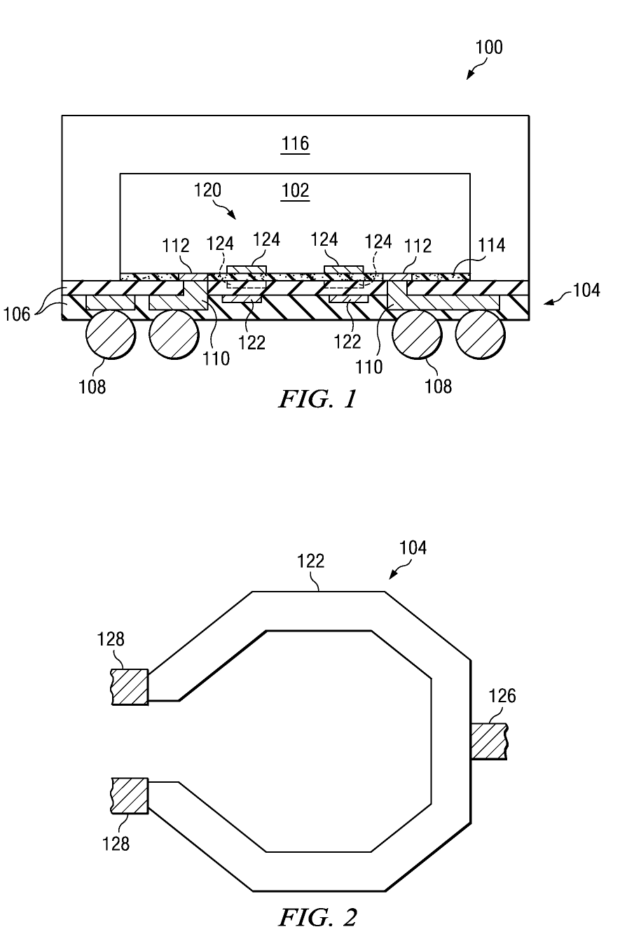

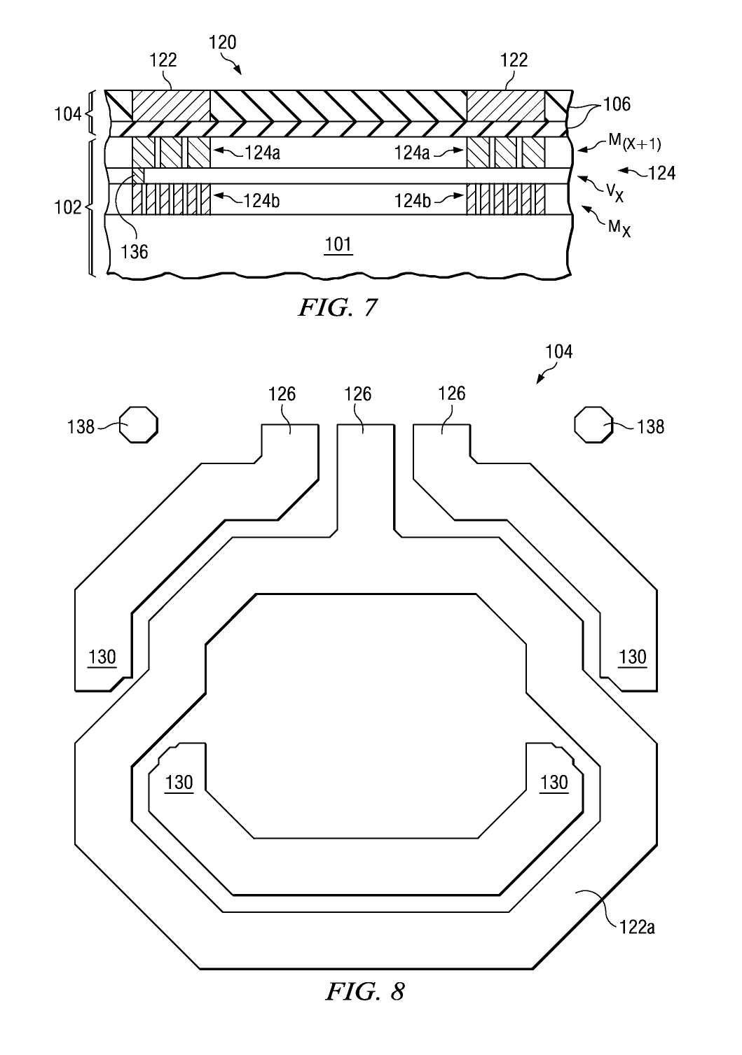

With reference now to FIG. 1, there is shown a cross-sectional view of a packaged semiconductor workpiece 100 in accordance with embodiments of the present invention, wherein at least a portion of a winding 122 of a transformer 120 is disposed in a redistribution layer 104 of a packaging system for the semiconductor workpiece 102. The semiconductor workpiece 102 may comprise a semiconductor device, a semiconductor chip, a semiconductor body, a semiconductor wafer, or a substrate, as examples. The semiconductor workpiece 102 may comprise an integrated circuit and may include active components or circuits, not shown. The semiconductor workpiece 102 may include conductive material layers and/or other types of semiconductor elements, e.g., transistors, capacitors, diodes, etc. The semiconductor workpiece 102 may comprise at least a portion of a circuit comprising a radio frequency (RF) circuit, an analog circuit, a power amplifier device, or other types of circuits formed a substrate (see substrate 101 shown in FIG. 7, to be described further herein), for example.

The packaging system shown in FIG. 1 may comprise a wafer level ball grid array (WLB) package or an embedded WLB package, as examples. Alternatively, the packaging system of the packaged semiconductor workpiece 100 may comprise other types of packaging systems that include a redistribution layer 104, for example. The WLB package comprises a plurality of solder ball contacts 108 disposed on one surface thereof. The solder ball contacts 108 may be positioned in an array comprising shapes such as a square or rectangle, or an array in a central region. The solder ball contacts 108 may also be positioned in rows at a perimeter region, as shown in FIG. 1.

The redistribution layer 104 of the WLB package includes one or more insulating material layers 106. Conductive lines 110 are formed in the redistribution layer 104. In an embodiment, the conductive lines 110 may be formed of a metal (for example, a pure metal or a metal alloy). Alternatively, the conductive lines 110 may comprise other conductive materials. The conductive lines 110 are bonded or coupled to contact pads 112 of the semiconductor workpiece 102. The conductive lines 110 comprise conductive lines in the insulating material layer(s) 106 that couple the plurality of solder ball contacts 108 to contact pads 112 of the semiconductor workpiece 102.

The semiconductor workpiece 102 may be attached to the redistribution layer 104 by an adhesive 114. The contact pads 112 may be soldered to the conductive lines 110 of the redistribution layer 104, which may comprise bond pads on the top surface thereof to couple to the contact pads 112 of the semiconductor workpiece 102. The contact pads 112 may alternatively be attached to the conductive lines 110 using a conductive adhesive, for example. An encapsulating material 116 may be disposed over the entire package, over the redistribution layer 104 and the semiconductor workpiece 102.

In accordance with embodiments of the present invention, the packaged semiconductor workpiece 100 includes a transformer 120 having at least a portion of at least one winding formed or disposed in the redistribution layer 104 of the packaging system. At least a portion of a first winding 122 of the transformer 120 is disposed in the redistribution layer 104 of the packaging system in the embodiment shown in FIG. 1, for example.

In some embodiments, at least a portion of a second winding 124 of the transformer 120 is disposed in at least one conductive material layer of the semiconductor workpiece 102. The second winding 124 is disposed proximate the first winding 122, as shown in FIG. 1; e.g., the portions of the windings 122 and 124 are stacked vertically over one another. In other embodiments, at least a portion of a second winding 124 of the transformer 120 is disposed in the redistribution layer 104 of the packaging system proximate the first winding 122, as shown in phantom in FIG. 1, to be described further herein.

The entire first winding 122 may be formed in the redistribution layer 104, or only portions of the first winding 122 may be formed in the redistribution layer 104. If the first winding 122 comprises more than one turn, cross-overs of the first winding 122 may be formed in a conductive material layer of the semiconductor workpiece 102, for example. The entire second winding 124 may be formed in the redistribution layer 104 or in the semiconductor workpiece 102. Alternatively, only portions of the second winding 124 may be formed in the redistribution layer 104, and cross-overs of the second winding 124 may be formed in a conductive material layer of the semiconductor workpiece 102. Alternatively, the second winding 124 may be formed in one or more conductive material layers of the semiconductor workpiece 102, e.g., the second winding 124 may be formed in several conductive material layers, comprising a vertical spiraling loop connected by vias between the conductive material layers in the semiconductor workpiece 102.

The first winding 122 may comprise the primary winding of the transformer 120 in some applications, and the second winding 124 may comprise the secondary winding. Alternatively, in other applications, the first winding 122 may comprise the secondary winding of the transformer 120, and the second winding 124 may comprise the primary winding.

Several examples of embodiments of the invention will next be described. FIGS. 2 through 4 illustrate an embodiment wherein the entire first winding 122 of a transformer 120 is formed in a redistribution layer 104 of a packaging system, and the entire second winding 124 of the transformer 120 is formed in a conductive material layer of a semiconductor workpiece 102. FIG. 2 illustrates a top view of a first winding 122 of a transformer 120 disposed in a redistribution layer 104 of a packaging system. The first winding 122 may comprise copper, other metals, metal alloys, or other conductive materials, as examples. The first winding 122 comprises a continuous loop of conductive material that is ring-shaped. The first winding 122 may comprise an octagonal or circular shape in a top view. The width of the first winding 122 depends on the desired parameters of the transformer 120, e.g., on the desired inductance, impedance, or other parameters, of the first winding 122 in the application. The first winding 122 may be coupled at each end to terminals 128 and other regions along the first winding 122 to optional conductive lines 126 formed in the redistribution layer 104, for example, as shown. The first winding 122 may be coupled at each end to a terminal 128, wherein the terminal 128 comprises a voltage supply terminal, a voltage return terminal, or a terminal for a signal, for example.

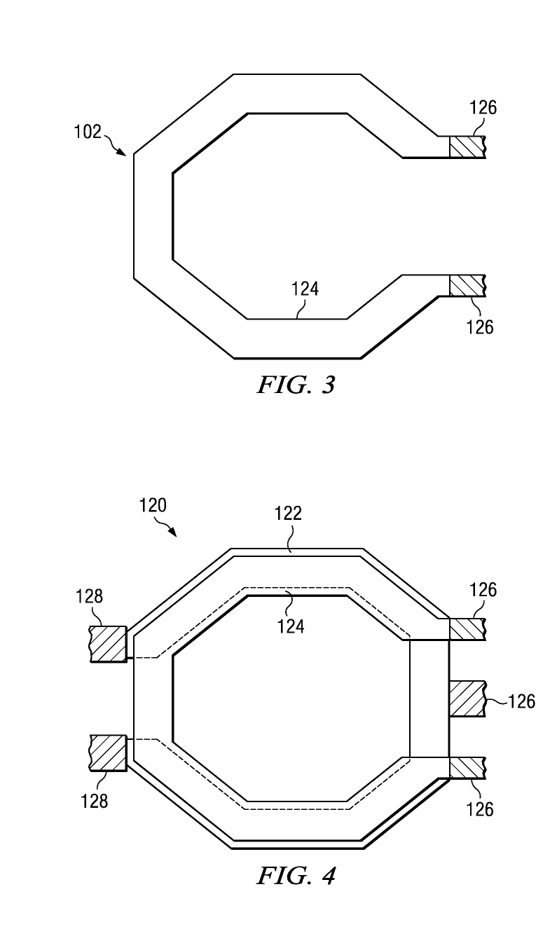

FIG. 3 shows a top view of a second winding 124 of a transformer 120 that includes the first winding 122 shown in FIG. 2. The second winding 124 is disposed or formed in a conductive material layer of a semiconductor workpiece 102. The second winding 124 may comprise a similar size and/or shape as the first winding 122.

In the embodiment shown in FIGS. 2 through 4, the second winding 124 comprises the same number of turns as the first winding 122. Thus, the transformer 120 comprises a 1:1 turn ratio. The first winding 122 may comprise a first number of turns, and the second winding 124 may comprise a second number of turns, wherein the second number of turns is the substantially the same as the first number of turns. Alternatively, the second number of turns of the second winding 124 may be different than the first number of turns, for example, to form a transformer 120 having other than a 1:1 turn ratio.

The second winding 124 may comprise substantially the same width as the first winding 122, as shown, or alternatively, the second winding 124 may comprise a different width, e.g., greater than or less than the width of the first winding 122, not shown. The second winding 124 may comprise a substantially mirror image of the first winding 122 in some embodiments, as shown.

Conductive lines 126 may be coupled to ends of the second winding 124, as shown. The conductive lines 126 may be connected to a voltage supply terminal, a voltage return terminal, or a terminal for a signal elsewhere in the conductive material layer of the semiconductor workpiece 102 or in the packaged semiconductor workpiece 100, for example.

FIG. 4 shows a top view of the second winding 124 of FIG. 3 disposed over the first winding 122 of FIG. 2. The second winding 124 is disposed substantially over the first winding 122 over the entire loop in the packaged semiconductor workpiece 100, so that the second winding 124 and the first winding 122 function as a transformer 120.

In the embodiment shown in FIGS. 2 through 4, the first and second windings 122 and 124 each comprise one full turn or a single loop. Alternatively, in other embodiments, the first and second windings 122 and 124 may comprise different numbers of turns, or the first and second windings 122 and 124 may both comprise multiple numbers of turns. Furthermore, the second windings 124 may be formed in multiple conductive material layers of the semiconductor workpiece 102.

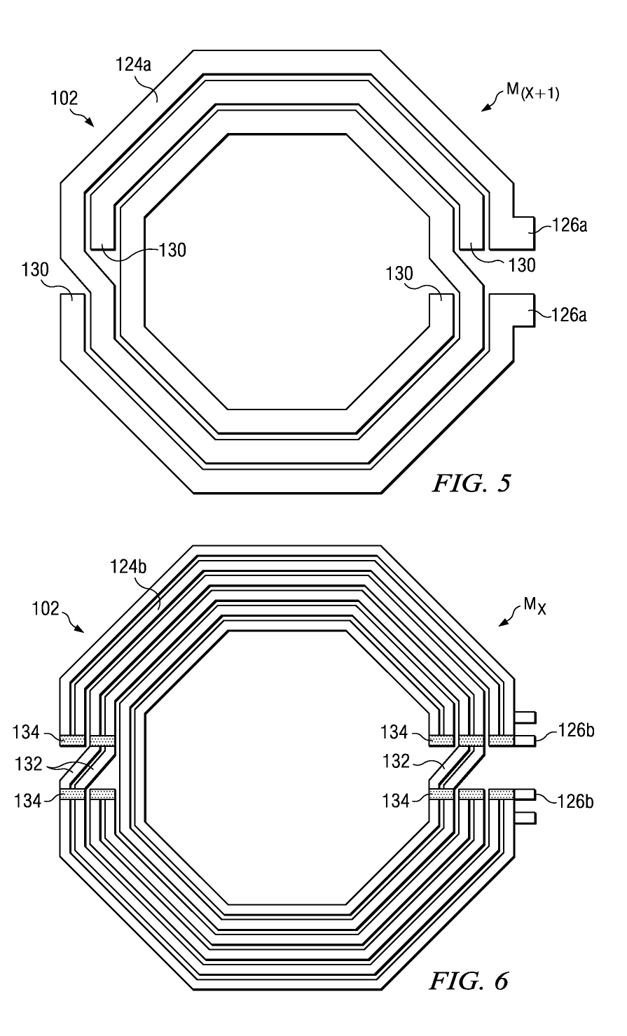

For example, FIGS. 5 and 6 show top views of portions 124a and 124b of a second winding 124 of a transformer 120 formed in two conductive material layers M₍ₓ₊₁₎ and Mₓ of a semiconductor workpiece 102. FIG. 7 shows a cross-sectional view of a transformer 120 having a first winding 122 in a redistribution layer 104 as shown in FIG. 2 disposed over the semiconductor workpiece 102 shown in FIGS. 5 and 6. Note that the view in FIG. 7 is inverted or upside-down from the view of the packaged semiconductor workpiece 100 shown in FIG. 1: the redistribution layer 104 is shown on top of the semiconductor workpiece 102 in the view shown in FIG. 7, whereas the redistribution layer 104 is shown beneath the semiconductor workpiece 102 in the packaged semiconductor workpiece 100 in FIG. 1.

The semiconductor workpiece 102 includes a substrate 101, shown in FIG. 7. The substrate 101 may comprise silicon or other semiconductive materials, for example. The substrate 101 may comprise a semiconductor wafer, in some embodiments. The substrate 101 may optionally covered by an insulating layer, for example, not shown. The substrate 101 may comprise silicon oxide over single-crystal silicon, as an example. Compound semiconductors, GaAs, InP, Si/Ge, or SiC, as examples, may be used in place of silicon. The substrate 101 may comprise a silicon-on-insulator (SOI) or a germanium-on-insulator (GOI) substrate, as examples.

The semiconductor workpiece 102 includes a plurality of conductive material layers Mₓ, Vₓ, M₍ₓ₊₁₎ formed over the substrate 101 proximate a top surface of the semiconductor workpiece 102. Conductive lines (not shown) are formed in other regions of the conductive material layers Mₓ and M₍ₓ₊₁₎, and vias (also not shown) are formed in other regions of the conductive material layer Vₓ. Conductive material layer M₍ₓ₊₁₎ comprises a top-most conductive material layer of the semiconductor workpiece 102, and conductive material layer Mₓ comprises a second conductive material layer disposed below the conductive material layer M₍ₓ₊₁₎. The via layer Vₓ is disposed between the conductive material layers M₍ₓ₊₁₎ and Mₓ and is used to make connections between conductive lines in the two conductive material layers M₍ₓ₊₁₎ and Mₓ.

FIG. 5 shows a top view of the top-most conductive material layer M₍ₓ₊₁₎ of a semiconductor workpiece 102 including at least one portion 124a of a second winding 124 comprising three turns. FIG. 6 shows a conductive material layer Mₓ proximate the top-most conductive material layer M₍ₓ₊₁₎ including at least one portion 124b of the second winding 124 comprising three turns. Note that the portions 124b of the second winding 124 are optional; alternatively, the second winding 124 may be completely formed in the top-most conductive material layer M₍ₓ₊₁₎. Alternatively, portions of the second winding 124 may also be formed in three or more conductive material layers disposed beneath the conductive material layer Mₓ, for example, not shown.

Conductive lines formed in other regions of the conductive material layers may comprise a greater width in a top view in the top-most conductive material layer M₍ₓ₊₁₎ than in the conductive material layer Mₓ. The portions 124a of the second winding 124 may also comprise a greater width than portions 124b of the second winding 124; e.g., in the embodiment shown, each turn of the portion 124b of the second winding 124 in conductive material layer Mₓ comprises two conductive lines that run parallel to one another along their length, curving or bending at the same regions.

Vias 136 may be used to connect the portions 124a and 124b of the second winding 124 in the via layer Vₓ disposed between the conductive material layers M₍ₓ₊₁₎ and Mₓ. The portion 124b of the second winding 124 in conductive material layer Mₓ may include landing pads 134 that provide a place for the vias 136 to land on to connect to ends 130 of the portions 124a in conductive material layer M₍ₓ₊₁₎. The landing pads 134 are also used to couple together the parallel conductive line portions 124a in conductive material layer Mₓ.

Some ends 130 of portions 124a of the second winding 124 in the conductive material layer M₍ₓ₊₁₎ may be connected together by cross-overs 132 of the adjacent conductive material layer Mₓ, e.g., using one or more vias 136 disposed between the portions 124a and 124b of the second winding 124. As in the previous embodiment, some ends of the portions 124a and 124b of the second winding 124 in the conductive material layers M₍ₓ₊₁₎ and Mₓ may be coupled to conductive lines 126a and 126b, respectively. The conductive lines 126a and 126b may be connected to a voltage supply terminal, a voltage return terminal, or a terminal for a signal elsewhere in the conductive material layer of the semiconductor workpiece 102 or in the packaged semiconductor workpiece 100, for example.

Portions 124b of the second winding 124 are disposed proximate portions 124a of the second winding 124 vertically in the packaged semiconductor workpiece 100. Portions 124a of the second winding 124 are disposed proximate the first winding 122 in the redistribution layer 104 shown in FIG. 2, forming the transformer 120.

In the embodiment shown in FIGS. 2 and 5 through 7, the second winding 124 comprises a different number of turns than the first winding 122. The second winding 124 has a greater number of turns than the first winding 122. The first winding 122 has one turn and the second winding 124 has three turns in two conductive material layers Mₓ and M₍ₓ₊₁₎. Thus, the transformer 120 comprises a 1:3 turn ratio. Alternatively, the first winding 122 may have a greater number of turns than the second winding 124, for example.

The portions 124a and 124b of second winding 124 comprise different widths than the first winding 122, as can be seen in the top views in FIGS. 2, 5, and 6. For example, the widths of the portions 124a and 124b of the second winding 124 are less than the width of the first winding 122.

The portions 124a and 124b of the second winding 124 may also comprise different thicknesses than the thickness of the first winding 122 in the vertical direction in the cross-sectional view of FIG. 7. The first winding 122 may have a greater thickness than the second winding 124, in some embodiments, because conductive lines in the redistribution layer 104 may be thicker than conductive lines on the semiconductor workpiece 102. This may be advantageous in some applications, because the quality factor of the transformer 120 may be improved and the impedance of the first winding 122 may be decreased.

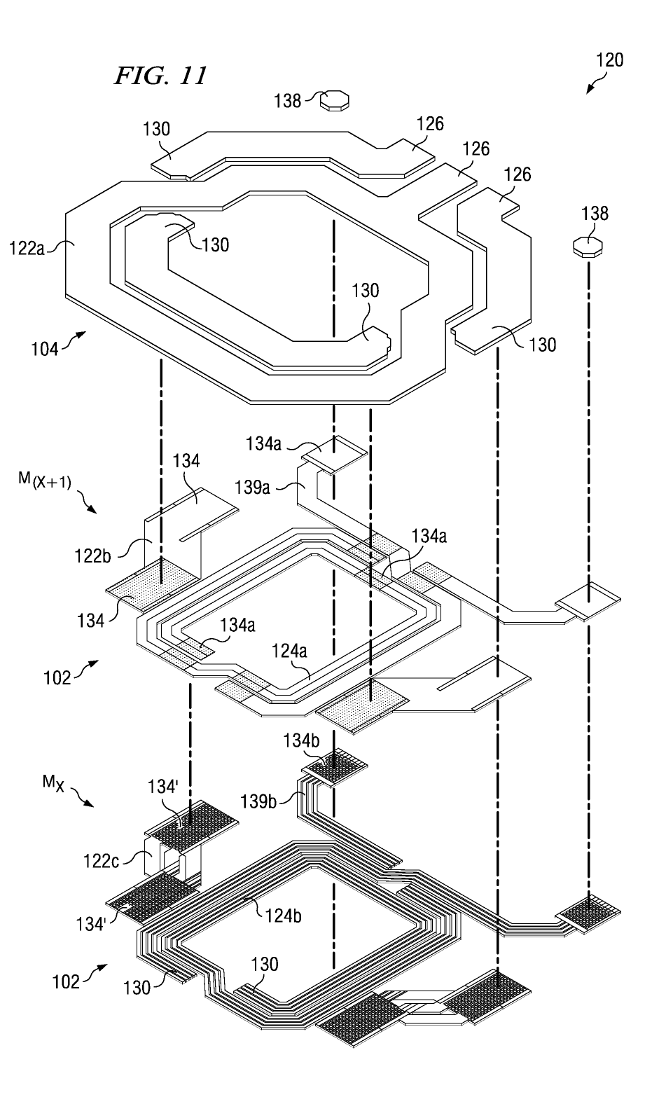

FIGS. 8 through 10 show top views of portions of windings 122 and 124 of a transformer 120 in accordance with another embodiment. FIG. 11 shows a perspective view of the transformer 120 comprising the windings 122 and 124 of FIGS. 8 through 10 disposed over one another.

In FIG. 8, a first portion 122a of a first winding 122 formed in a redistribution layer 104 is shown. The first portion 122a of the first winding 122 comprises two turns in this embodiment. The first portion 122a comprises at least one first portion 122a; e.g., the first portion 122a may comprise a plurality of first portions 122a. Contacts 138 that are used for coupling the redistribution layer 104 to the second winding 124 in the conductive material layers M₍ₓ₊₁₎ and Mₓ of the semiconductor workpiece 102 are also shown in FIG. 8. Electrical connections may be routed to the contacts 138 so that the second winding 124 may be coupled to a solder ball contact 108 of the packaged semiconductor workpiece 100 (see FIG. 1), for example.

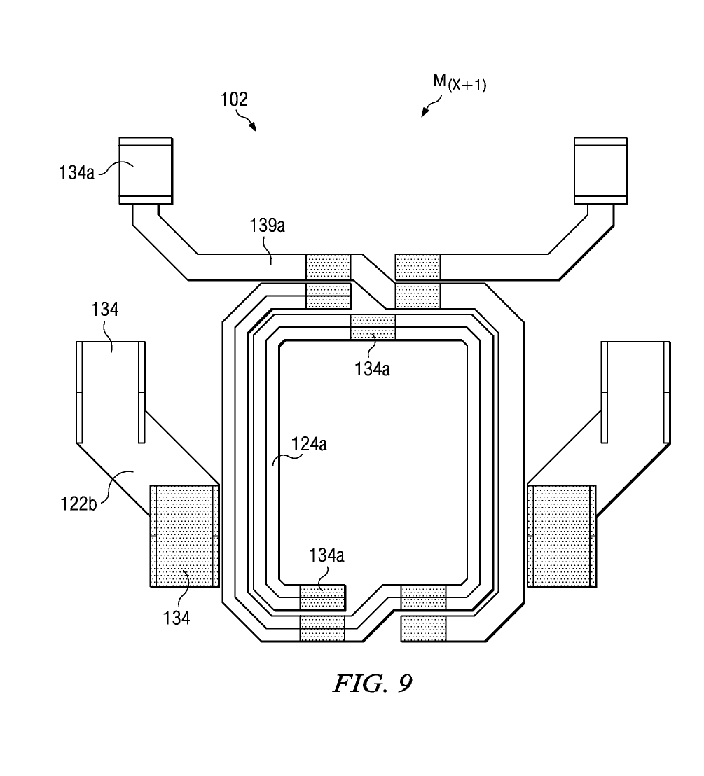

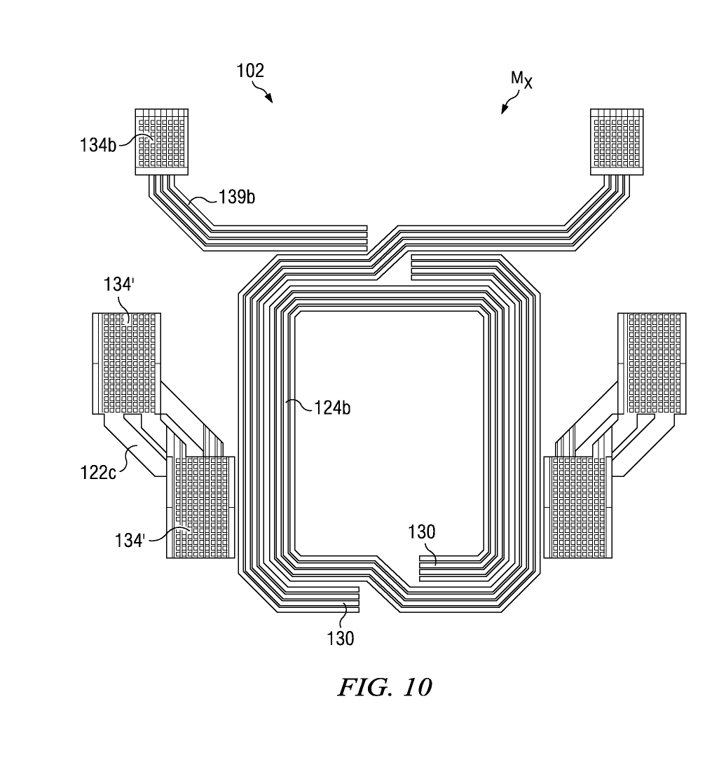

FIG. 9 shows a top view of the top-most conductive material layer M₍ₓ₊₁₎ of the semiconductor workpiece 102. A second portion 122b of the first winding 122 is formed in the conductive material layer M₍ₓ₊₁₎. The second portion 122b comprises at least one second portion 122b and may comprise a plurality of second portions 122b, as shown. The second portions 122b of the first winding 122 comprise cross-overs, e.g., crossings or bridges for the first winding 122 within the conductive material layer M₍ₓ₊₁₎ that couple together ends 130 of the first portion 122a of the first winding 122 shown in FIG. 8.

The first portions 122a and the second portions 122b of the first winding form an inductor of the transformer 120 comprising the first winding 122. The first winding 122 comprises a single winding formed from the first portions 122a in the redistribution layer 104 and the second portions 122b in the conductive material layer M₍ₓ₊₁₎ in the semiconductor workpiece 102.

Landing pads 134 may be coupled to each end of the second portions 122b of the first winding 122, as shown. A contact layer (not shown) in the semiconductor workpiece 102 may be used to make connections to the first portion 122a of the first winding 122 in the redistribution layer 104. Alternatively, the wiring for regions of the first portion 122a of the first winding 122 within the redistribution layer 104 may be extended to the surface of the redistribution layer 104 and may be bonded to the landing pads 134 using solder or conductive adhesive, for example, connecting the second portion 122b to the first portion 122a of the first winding 122 and completing the turns of the first winding 122, forming a continuous first winding 122.

The conductive material layer M₍ₓ₊₁₎ also includes a portion 124a or a plurality of portions 124a of the second winding 124 comprising two turns. Landing pads 134a may be included along some regions of the portion 124a of the second winding 124 for connecting the portions 124a of the second winding 124 to portions 124b of the second winding 124 in conductive material layer Mₓ shown in FIG. 10. Conductive lines 139a are also formed in the conductive material layer M₍ₓ₊₁₎ that are connected to the portions 124a of the second winding 124 at one end and to landing pads 134a at an opposite end. The conductive lines 139a are used to connect the second winding 124 to the contacts 138 in the redistribution layer 104 shown in FIG. 8.

FIG. 10 shows a portion or portions 124b of the second winding 124 formed in a conductive material layer Mₓ proximate the conductive material layer M₍ₓ₊₁₎. Portion 124b is optional; alternatively, the entire second winding 124 may be formed in conductive material layer M₍ₓ₊₁₎. Alternatively, the second winding 124 may be formed in three or more conductive material layers.

Conductive lines 139b may be used to connect the portions 124b of the second winding 124 to landing pads 134b, which may be coupled to landing pads 134a by one or more vias, not shown. Ends 130 of the portions 124b of the second winding 124 may be connected by vias to landing pads 134a along regions of the portions 124a of the second winding 124 in conductive material layer M₍ₓ₊₁₎, to make cross-overs for the portions 124b of the second winding 124 and complete the turns, forming a continuous second winding 124.

Optionally, cross-overs of the first winding 122 may also be made by third portions 122c of the first winding 122 formed in the conductive material layer Mₓ. The third portions 122c may be coupled to a landing pad 134′ at each end, and the landing pads 134′ may be coupled to landing pads 134 in conductive material layer M₍ₓ₊₁₎ using vias (not shown) in a via layer Vₓ disposed between conductive material layers Mₓ and M₍ₓ₊₁₎.

FIG. 11 illustrates that the turns of the second winding 124 are disposed vertically substantially over and proximate the first winding 122 in the packaged semiconductor workpiece 100, so that the second winding 124 and the first winding 122 function as a transformer 120.

The turns of the winding portions 124a may comprise one conductive line, as shown on the right side in FIG. 9, or the turns of the winding portions 124a may comprise two conductive lines, as shown on the other turns in FIG. 9. Alternatively, the turns of the winding portions 124b may comprise three or more conductive lines, as shown in FIG. 10.

The first winding 122 may have a low impedance and the second winding 124 may have a high impedance in some embodiments. This is an advantage in some applications where the source impedance is taken into consideration or accommodated for in the design, for example.

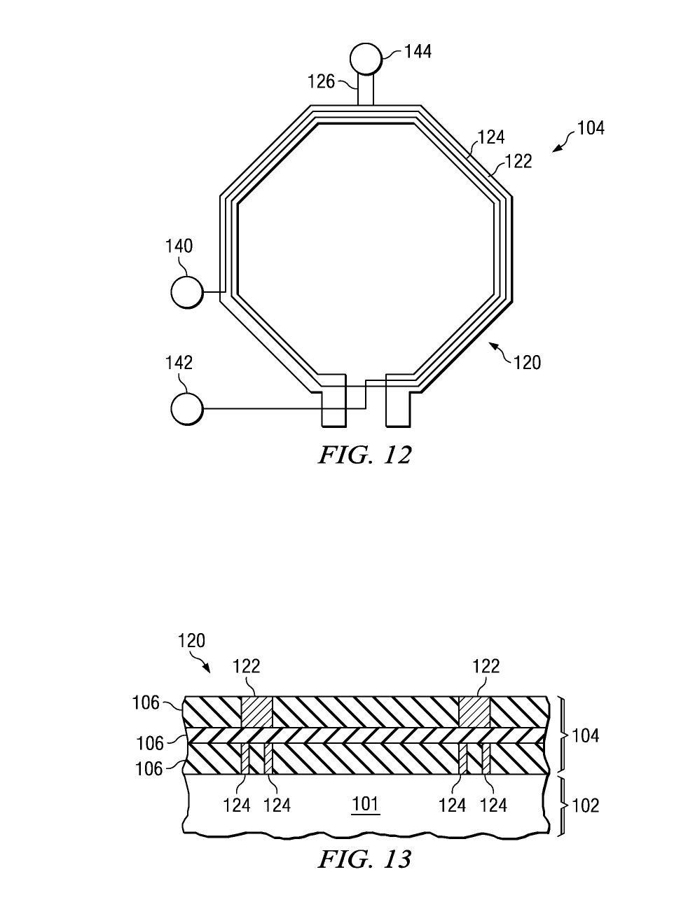

FIG. 12 shows a top view of another embodiment, wherein first and second windings 122 and 124 of a transformer 120 are both formed in a redistribution layer 104 of a packaging system of a semiconductor workpiece 102. FIG. 13 shows a cross-sectional view of the embodiment shown in FIG. 12. The first winding 122 has one turn or loop, and the second winding 124 has two turns or loops; thus, the turn ratio of the transformer 120 in this embodiment is 1:2.

The first and second windings 122 and 124 are disposed proximate one another vertically and are separated by insulating material 106 in the redistribution layer 104. Cross-overs, e.g., crossings or bridges, of the second winding 124 may be made in the upper conductive material layer of the semiconductor workpiece 102, not shown. This embodiment is advantageous because less space is required on the semiconductor workpiece 102, so that the semiconductor workpiece 102 may be made smaller, or the area saved in the semiconductor workpiece 102 may be used for other circuitry.

If the first and second windings 122 and 124 both comprise a single turn (e.g., one winding or a single loop), no cross-overs may be required in a conductive material layer of the semiconductor workpiece 102, so that the transformers 120 advantageously require no space at all on the semiconductor workpiece 102.

The embodiment shown in FIG. 12 also illustrates possible electrical connections that may be made to the transformer 120. A terminal for a signal 140 such as a transformer (TX) signal may be coupled to one end of the second winding 124, and a voltage return terminal 142 or ground terminal may be coupled to an opposite end of the second winding 124. A voltage supply terminal 144 may be coupled to a portion of the first winding 122. Alternatively, electrical connections may be made to the windings 122 and 124 of the transformer 120 in other configurations.

The first winding 122 may comprise a single wide primary winding that may be connected to a power amplifier in this embodiment, as an example. The second winding 124 may be used to convert the energy from the first winding 124, stepping up an alternating current in the first winding 122, as another example.

Embodiments of the present invention include transformers 120 and methods of manufacture thereof. The windings 122 and 124 and portions of the windings 122 and 124 may be manufactured using lithography and etch processes used in semiconductor device fabrication processes and/or using manufacturing processes for redistribution layers of packaging systems. Embodiments of the present invention also include semiconductor devices, integrated circuits, and semiconductor workpieces 102 including and utilizing the novel transformers 120 described herein. Embodiments also include packaged semiconductor workpieces 100 including the transformers 120 formed in at least a portion of the redistribution layer 104 of the packaging system.

Advantages of embodiments of the invention include providing novel transformer 120 designs that have improved quality or Q factors. The windings 122 and 124 comprise inductors of the transformers 120 that are formed in at least a portion of a redistribution layer 104 of a packaging system for the semiconductor workpieces 102. Transformers 120 with increased capability and turn ratios may be manufactured and included in at least a portion of the packaging systems for semiconductor devices. The transformers 120 may be formed in one or more conductive layers of redistribution layers 104 of packaging systems, saving space on semiconductor workpieces 102. The windings 122 and 124 of the transformers 120 are vertically stacked in one or more conductive material layers of a semiconductor workpiece 102 and/or in one or more conductive layers of a redistribution layer 104.

The first winding 122 may comprise a primary winding having a low impedance and a high quality in some embodiments, whereas the second winding 124 may comprise a secondary winding formed on the semiconductor workpiece 102 that has a higher impedance and may have a lower quality, which may be an advantage in some applications.

Although embodiments of the present invention and their advantages have been described in detail, it should be understood that various changes, substitutions and alterations can be made herein without departing from the spirit and scope of the invention as defined by the appended claims. For example, it will be readily understood by those skilled in the art that many of the features, functions, processes, and materials described herein may be varied while remaining within the scope of the present invention. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A transformer, comprising:
a semiconductor workpiece; and
a packaging system disposed over the semiconductor workpiece, the packaging system including a redistribution layer, wherein at least a portion of at least one winding of the transformer is disposed in the redistribution layer of the packaging system.

2. The transformer according to claim 1, wherein at least a portion of a first winding of the transformer is disposed in the redistribution layer of the packaging system, and wherein at least a portion of a second winding of the transformer is disposed in at least one conductive material layer of the semiconductor workpiece proximate the at least the portion of the first winding.

3. The transformer according to claim 2, wherein the at least the portion of the first winding comprises at least a portion of a primary winding, and wherein the at least the portion of the second winding comprises at least a portion of a secondary winding.

4. The transformer according to claim 2, wherein the at least the portion of the first winding comprises at least a portion of a secondary winding, and wherein the at least the portion of the second winding comprises at least a portion of a primary winding.

5. The transformer according to claim 1, wherein at least a portion of a first winding of the transformer is disposed in the redistribution layer of the packaging system, and wherein at least a portion of a second winding of the transformer is disposed in the redistribution layer of the packaging system proximate the at least the portion of the first winding.

6. The transformer according to claim 5, wherein the at least the portion of the first winding comprises at least a portion of a primary winding, and wherein the at least the portion of the second winding comprises at least a portion of a secondary winding.

7. The transformer according to claim 5, wherein the at least the portion of the first winding comprises at least a portion of a secondary winding, and wherein the at least the portion of the second winding comprises at least a portion of a primary winding.

8. A semiconductor device, comprising:
a semiconductor workpiece; and
a packaging system disposed over the semiconductor workpiece, the packaging system including a redistribution layer, wherein the semiconductor device includes a transformer having at least a portion of a winding disposed in the redistribution layer of the packaging system.

9. The semiconductor device according to claim 8, wherein the at least the portion of the winding of the transformer in the redistribution layer comprises at least a portion of a first winding, wherein the transformer further comprises at least a portion of a second winding disposed in a conductive material layer of the semiconductor workpiece or in the redistribution layer.

10. The semiconductor device according to claim 9, wherein the at least the portion of the first winding comprises a first number of turns, wherein the at least the portion of the second winding comprises a second number of turns, wherein the second number of turns is substantially the same as the first number of turns.

11. The semiconductor device according to claim 9, wherein the at least the portion of the first winding comprises a first number of turns, wherein the at least the portion of the second winding comprises a second number of turns, wherein the second number of turns is different than the first number of turns.

12. The semiconductor device according to claim 8, wherein the at least the portion of the winding comprises at least one first portion of the winding, wherein the winding of the transformer further comprises at least one second portion, the at least one second portion being disposed in a conductive material layer of the semiconductor workpiece.

13. The semiconductor device according to claim 12, wherein the at least one first portion and the at least one second portion comprise an inductor of the transformer, the inductor including a continuous winding of the at least one first portion and the at least one second portion.

14. The semiconductor device according to claim 12, wherein the at least one second portion of the winding comprises a cross-over connection coupling together at least two first portions of the winding in the redistribution layer of the packaging system.

15. The semiconductor device according to claim 8, wherein the at least the portion of the winding of the transformer in the redistribution layer comprises at least a portion of a first winding, wherein the transfornier further comprises at least a portion of a second winding disposed in a conductive material layer of the semiconductor workpiece, wherein the at least the portion of the first winding comprises a first thickness, wherein the at least the portion of the second winding comprises a second thickness, the first thickness being greater than the second thickness.

16. The semiconductor device according to claim 8, wherein the semiconductor workpiece comprises a semiconductor chip, an integrated circuit, a semiconductor body, a semiconductor wafer, or a substrate.

17-24. (canceled)

25. The semiconductor device of claim 14, wherein the cross-over connection is disposed in a conductive material layer of the semiconductor workpiece.

26. A circuit comprising:
a semiconductor workpiece, the semiconductor workpiece comprising a conductive material layer comprising at least a portion of a first winding of a transformer; and
a redistribution layer disposed on the semiconductor workpiece, the redistribution layer comprising at least a portion of a second winding of the transformer.

27. The circuit of claim 26, wherein:
the first winding comprises a first number of turns;
the second winding comprises a second number of turns.

28. The circuit of claim 27, wherein a ratio of the first number of turns to the second number of turns is about 1:1.

29. The circuit of claim 26, further comprising a package disposed on the semiconductor workpiece, the package including the redistribution layer.

30. The circuit of claim 29, wherein the package comprises a wader level ball grid array (WLB) package, the WLB package comprising a plurality of solder ball contacts coupled contact pads of the semiconductor workpiece.

31. The circuit of claim 26, further comprising a useful circuit disposed on the semiconductor workpiece.

32. The circuit of claim 31, wherein the useful circuit comprises a radio frequency (RF) circuit.
